(19) United States
(12) Patent Application Publication
(10) Pub. No.: US 2005/0065816 A1
(43) Pub. Date: Mar. 24, 2005

(54) Healthcare management information system

(76) Inventors: Michael Borg Limberg, San Luis Obispo, CA (US); Tien Manh Nguyen, Anaheim, CA (US)

Correspondence Address: LAW OFFICE OF PHILIP A STEINER, 846 HIGUERA STREET, SUITE 11, SAN LUIS OBISPO, CA, 93401, US

(21) Appl. No.: 10/668,816

(22) Filed: Sep. 22, 2003

(51) Int. Cl. G06F 17/60

(52) U.S. Cl. 705/2; 705/35

(57) ABSTRACT

A method, system, data structure and computer program product for generating a visual compliance display. Different compliance obligations are provided as is a first user interface having a first input area, a second input area, and a status area. First input data relating to information and associated with a compliance obligation is received typically from a health care provider, the first input data provided to the first input area. Based on compliance obligations satisfied by the first input data, a first scalable level of compliance is automatically determined. Within the status area of the first user interface an indication based on the first scalable level of compliance is then automatically displayed. Second input data relating to information and associated with a compliance obligation is received, typically from a health care provider, the second input data provided to the second input area. Based on compliance obligations satisfied by the first and second input data, a second scalable level of compliance is automatically determined. Within the status area of the first user interface an indication based on the second scalable level of compliance is then automatically displayed. Additional embodiments of the invention provide for an integrated healthcare management information system.

### CROSS-REFERENCE TO RELATED APPLICATIONS

Not applicable.

### FEDERALLY SPONSORED RESEARCH AND DEVELOPMENT

Not Applicable.

### REFERENCE TO A MICROFICHE APPENDIX

Not Applicable.

### COPYRIGHT NOTICE

A portion of the disclosure of this patent document contains material which is subject to copyright protection. The copyright owner has no objection to the facsimile reproduction by anyone of the patent document or the patent disclosure, as it appears in the Patent and Trademark Office patent file or records, but otherwise reserves all copyright rights whatsoever.

### FIELD OF INVENTION

The instant invention relates generally to a healthcare management information system report for healthcare service providers, and more specifically to a healthcare management information system which includes mechanisms to automatically and contemporaneously provide claim and billing feedback while a healthcare provider enters client information into the system.

### BACKGROUND

Service providers use a variety of systems to record, report and bill for the services they provide. These systems vary in structure and complexity based on the information requirements of the service provider, its customers, and any third parties reviewing the services. While many service providers have flexibility in choosing their form of billing, record keeping and reporting systems, some are more constrained in what they must record, report and bill for their services. An example of the latter includes physicians, dentists, opticians, technicians and other health care service providers, who are typically paid for their services by third party payors, which, in the United States, include private insurance carriers or the federal government, utilizing either the Medicare or Medicaid program.

Typically, health care service providers must comply with all of the complex reporting requirements imposed by a third party payor and with any applicable legislation in order to receive payment or partial payment for health care related products and services rendered to patients and/or customers. Errors in reports or bills, or nonconformance(s) with third party reporting or billing requirements in many cases results in a denial, partial or delay in payment for services and furthermore could expose the healthcare provider to civil and criminal penalties. Although such a delay, partial or denial of payment can apply to services provided by any service provider who seeks payment or partial payment from a third party, delay or denial of payment for services is particularly problematic in the health care field.

To add to the complexity, in addition to insurance carriers, the federal government and other organizations frequently and dynamically impose their own billing and reporting conditions on the health care providers. However, there has begun to emerge some consensus in the reporting requirements required by the insurance industry and the federal government—at least to the extent each health care provider is required to use common service codes to identify the particular cognitive and non-cognitive care they render to their patients.

In the parlance of the industry, cognitive care refers generally to services that principally involve mental processes and exercise of professional judgment of the health care provider performing an evaluation of a patient. Services considered non-cognitive care on the other hand tend to be those that involve more physical interaction with a patient such as performing invasive or non-invasive procedures, clinical tests, and treatments. In addition to documenting the type of care rendered, diagnostic information is required in many cases. For example, when billing for and reporting non-cognitive care, a health care provider may have to indicate a health care condition or disease, and the particular diagnostic indications that the payor deems to adequately medically support the particular type of non-cognitive care recommended for the patient.

Requirements for proper coding of a patient's health care condition and the diagnostic indications which support a proposed non-cognitive level of care, as well as the detailed requirements for identifying the particular cognitive level of care administered by a physician during an office visit or hospital in-patient visit, have been annunciated primarily by the Health Care Financing Administration (HCFA) of the United States Government, in conjunction with the American Medical Association (AMA). The codes currently publicized by HCFA to identify types of care rendered are the health care procedure coding system (HCPCS) codes. The HCPCS codes include AMA promulgated codes identifying cognitive and non-cognitive levels of care, referred to as cognitive Current Procedural Terminology (CPT) codes and non-cognitive Current Procedural Terminology (CPT) codes.

The codes selected by the HCFA to identify the health care condition of the patient are commonly referred to as the International Classification of Diseases (ICD) codes.

In order for a physician to be paid promptly upon the submission of an insurance claim, the physician must ensure that the proper codes are all properly set forth on the claim form. Failure to provide the proper codes for the procedures administered or recommended will likely result in either a denial of payment or a substantial delay in payment of the claim. Needless to say, delays as well as denials of payment have a substantial negative impact on the financial condition of both the physician and his or her practice.

Going now from abstract scenarios and theorems to a more concrete example, it is noted that in the United States, by October 2003, Medicare, a US government healthcare payor, requires electronic submission of healthcare claims. Most physicians currently use a clearinghouse to process and submit the claims to both Medicare and private insurers, which adds to costs but also considerably complicates records management and billing reconciliation. A typical medical office adheres to the following mode of operation with respect to billing and reporting for services rendered to a patient. At the time the physician sees the patient, the physician notes, either in writing or through dictation, his observations of the patient and the patient's symptom descriptions. Based on the symptoms and observations, the physician then makes a disease diagnosis and recommends a plan of treatment.

Well after the patient has left the office, the billing department or the office staff reviews the physician's notes for being transcribed into the insurance claim form. During such review, the office staff attempts to interpret the physician's notes and assign the proper codes to the services. In particular, the office staff attempts to assign the proper ICD-9 code, cognitive and non-cognitive CPT code, and any diagnostic indication codes necessary to support a claim for rendered services based on the physician's notes. The insurance claim form is then prepared and submitted to the patient's insurance carrier.

The insurance carrier typically responds within thirty days with payment or a claim denial based on particular grounds. In response to a claim denial, the physician assisted by her or his staff faces the task of trying to retrace their steps. Typically, coding errors result from inaccuracies in interpreting or translating the physician's notes. Each claim denial adds at least another thirty days into the insurance provider's claim processing cycle and, therefore, delays payment by at least that same amount of time.

The current generations of healthcare management information systems are often difficult to maintain, and include proprietary data structures that make a linking to reporting and accounting modules difficult or virtually impossible. The pricing structure of these systems is almost monopolistic in nature. Once a practitioner has used one of these systems for any length of time, they become completely dependent on the vendor for updates, error corrections and improvements to the software.

In view of the above outlined problems, it has been recognized that a need exists for at least a method and apparatus for generating an insurance claim or other billing report and a medical procedure report that results in accurate report generation the first time and facilitates report generation by a single operator at substantially the same time as at least a portion of the services are rendered. It has further been recognized that there exists a need for a method and apparatus that also provides a mechanism for accurately and expediently verifying compliance with third party reporting requirements prior to submission of the billing report for payment to the third party to facilitate rapid entry of all information necessary to generate an accurate and complete billing report that is acceptable to the third party.

For example, in U.S. patent application No 2003/0083903 to Myers, published May 1, 2003, a system is disclosed for generating a billing report for rendered services that includes local and remote processing devices. The local processing device is disposed proximate a location at which the services are rendered and the remote-processing device is located remotely with respect to such location.

The local and remote processing devices execute respective software programs and communicate in a particular manner over a wide area computer network such that a service provider using the local processing device is able to access the remote processing device and enter parameters related to services for use in generating the billing report. Entry of the parameters preferably occurs substantially during the time period when the services are being rendered and the parameters are preferably acceptable to a third party payor that is at least partially responsible for payment for the services. The remote-processing device preferably verifies compliance of the entered parameters with reporting requirements of the third party and, if the entered parameters comply, generates the billing report based on the entered parameters.

The relevant art and proposed databases each address some of the above-described billing complexities but do not address all of the complexities in a fashion suitable for convenient day-to-day use. These systems often overlook the more common health care provider requirements such as scheduling of patient appointments and matching patient and physician schedules for setting appointments. Furthermore, the relevant art systems lack the ability to centralize record keeping, scheduling, and other organizing tasks for supporting modern multi-office implementations. Most importantly, the relevant art systems typically require duplication of data entry increasing the chances for billing errors and other mishaps.

None of the relevant art or proposed generation of healthcare management information systems (MIS) effectively addresses the common needs of elective type health care practices such as those providing laser corrective eye surgery (e.g., Lasik), plastic surgery, dental teeth whitening, whole body scans, etc. These practices may incorporate a more traditional medical component—services are rendered on an as needed basis—and an elective component—services are rendered because they are desired. For the traditional medical component, an MIS system that addresses the needs of the health care community typically suffices.

For elective health care, an entirely new set of MIS requirements exists. For example, collection of demographics of prospective patients is highly desirable for elective health care providers since it is useful in establishing client awareness, tracking advertising effectiveness and targeting marketing efforts to prospective clients.

Lastly, relevant art systems fail to integrate financial accounting functionality into the healthcare management information system (MIS) which necessarily requires duplicative input of information, maintenance of multiple databases and additional support staff to enter and maintain the multiple systems.

Thus, it would be advantageous to provide a healthcare management information system (MIS) for automatic billing generation and submission, thus bypassing third party clearinghouses, the system being scalable for small and large practices. It would further advantageous to provide an integrated healthcare management information system (MIS) including integrated healthcare record keeping, financial accounting, scheduling and billing capabilities.

### SUMMARY

The invention addresses the limitations discussed above and provides an integrated and scalable healthcare management information system for automatic bill generation, submission and reconciliation, record keeping, financial management, data mining and scheduling suitable for implementation in a wide range of healthcare practices.

In accordance with an embodiment of the invention a method is provided for generating a visual compliance display comprising the steps of: providing a plurality of different compliance obligations; providing a first user interface having a first input area, a second input area, and a status area; receiving first input data relating to an information and associated with a compliance obligation, the first input data provided to the first input area; and automatically determining a first scalable level of compliance in dependence upon compliance obligations satisfied by the first input data.

The method continues by automatically displaying within the status area of the first user interface an indication based on the first scalable level of compliance; receiving second input data relating to another information and associated with a compliance obligation, the second input data provided to the second input area; automatically determining a second scalable level of compliance in dependence upon compliance obligations satisfied by the first input data and the second input data; and automatically displaying within the status area of the first user interface an indication based on the second scalable level of compliance.

In accordance with an embodiment of the invention a method is provided for generating a financial obligation statement for a non-gratuitous benefit provided to a client comprising the steps of: establishing an event with a client; determining a level of compliance with one or more requirements established by a third party payor in privity with said client; displaying said level of compliance; generating a financial obligation statement derived at least in part from said level of compliance; and transmitting said financial obligation statement to said third party payor.

In accordance with an embodiment of the invention a system is provided for generating a financial obligation statement for a non-gratuitous benefit provided to a client for provision to a third party payor comprising: a computer system comprising; a processor; a user interface coupled to the processor; a display interface coupled to the processor; a telecommunications apparatus coupled to the processor; a memory coupled to the processor, the memory having operatively stored therein a data structure comprising information associated with a client; and at least one application comprising instructions executable by the processor for carrying out the steps of: determining a level of compliance from the information, displaying the level of compliance on the display interface, generate a financial obligation statement from the information, and transmitting the financial obligation statement to the third party payor via the telecommunications apparatus.

In accordance with an embodiment of the invention an integrated healthcare management information system is provided comprising: a financial claim generation system comprising; a database management system, a data entry system, a financial obligation statement verification system, and a financial obligation statement submission system; and a claim reconciliation system comprising: a payment information receiving system, a payment information parsing system, a payment information reconciliation system for reconciling received payment information with claims generated and submitted by the financial claim generation system and a reconciliation error management system.

In accordance with an embodiment of the invention an integrated healthcare management information system is provided comprising: at least a remote server for receiving a request for retrieval of at least a portion of the information stored within the at least a remote server, for transferring the requested at least a portion of the information from the at least a remote server to the at least a client computer, and wherein the at least a client computer system is for displaying at least a portion of the transferred information using the end user customizable graphical user interface.

In accordance with an embodiment of the invention an integrated healthcare management information system is provided comprising: a networked server coupled to a substantially ODBC compliant database system having a plurality of relationally linked data structures, each data structure comprising; a patient healthcare data storage area; an events data storage area; a third party payor data storage area; a provider data storage area; and a payment data storage area, where the data storage areas each include at least one attribute in common with the patient healthcare table; and a client terminal comprising a processor, a user interface coupled to the processor, a display interface coupled to the processor and a communication apparatus for resulting in communication with the at least one networked server for extracting data from at least a portion of the plurality of relationally linked data structures and for storing data within at least a portion of the plurality of relationally linked data structures, the client terminal for executing at least one front end application compatible with the data structure and including an end user customizable graphical user interface.

In accordance with the invention, the integrated healthcare management information system includes a financial management data storage area for storing financial accounting information, profitability information, income information and expense information. Alternately, the integrated healthcare management information system includes a financial management interface for operatively coupling to a financial management database.

In accordance with the invention a processing system is provided for carrying out the steps of: providing a plurality of different compliance obligations; providing a first first input data relating to an information and associated with a compliance obligation, the first input data provided to the first input area; automatically determining a first scalable level of compliance in dependence upon compliance obligations satisfied by the first input data; automatically displaying within the status area of the first user interface an indication based on the first scalable level of compliance; receiving second input data relating to another information and associated with a compliance obligation, the second input data provided to the second input area; automatically determining a second scalable level of compliance in dependence upon compliance obligations satisfied by the first input data and the second input data; and automatically displaying within the status area of the first user interface an indication based on the second scalable level of compliance.

In accordance with the invention there is provided a computer readable medium having data stored thereon comprising: first instruction data for when executed providing a plurality of different compliance obligations; second instruction data for when executed providing a first user interface having a first input area, a second input area, and a status area; third instruction data for when executed receiving first input data relating to an information and associated with a compliance obligation, the first input data provided to the first input area; fourth instruction data for when executed automatically determining a first scalable level of compliance in dependence upon compliance obligations satisfied by the first input data.

A fifth instruction data for when executed automatically displaying within the status area of the first user interface an indication based on the first scalable level of compliance; sixth instruction data for when executed receiving second input data relating to another information and associated with a compliance obligation; the second input data provided to the second input area; seventh instruction data for when executed automatically determining a second scalable level of compliance in dependence upon compliance obligations satisfied by the first input data and the second input data; and eighth instruction data for when executed automatically displaying within the status area of the first user interface an indication based on the second scalable level of compliance.

In accordance with the invention there is provided a computer program product which includes the programs and associated data recorded on optical, magnetic or logical transportable digital recording media such as a CD ROM, floppy disk, data tape, DVD, flash RAM or removable hard disk for installation on a typical computer system such as a client, a server or a portable device such as pocket data assistant (PDA), laptop or PDA equipped cellular telephone. The programs and associated data may be stored on the transportable digital recording media in a code format including byte code, compiled, interpreted, compliable and interpretable.

### BRIEF DESCRIPTION OF THE DRAWINGS

The features and advantages of the invention will become apparent from the following detailed description when considered in conjunction with the accompanying drawings. Where possible, the same reference numerals and characters are used to denote like features, elements, components or portions of the invention. Optional components are generally shown in dashed lines. It is intended that changes and modifications can be made to the described embodiment without departing from the true scope and spirit of the subject invention as defined in the claims.

FIG. 1 displays a flow chart illustrating the steps of a method for generating a visual compliance display.

FIG. 2 displays a flow chart illustrating the steps of a method for generating a financial obligation statement.

FIG. 3 displays a flow chart illustrating the steps of a method for automatic reconciliation of payment information received from third party payors.

FIG. 4a is a screenshot illustrating an initial menu according to an embodiment of the instant invention.

FIG. 4b is a screenshot illustrating an appointment menu according to an embodiment of the instant invention.

FIG. 4c is a screenshot illustrating patient selection according to an embodiment of the instant invention.

FIG. 4d is a screenshot illustrating patient demographics according to an embodiment of the instant invention.

FIG. 4e is a screenshot illustrating patient insurance information according to an embodiment of the instant invention.

FIG. 4f is a screenshot illustrating an electronic medical record of a patient according to an embodiment of the instant invention.

FIG. 4g is a screenshot illustrating updating an electronic medical record of a patient according to an embodiment of the instant invention.

FIG. 4h is a screenshot illustrating a decision process of a physician according to an embodiment of the instant invention.

FIG. 4i is a screenshot illustrating a billing procedure according to an embodiment of the instant invention.

FIG. 4k is a screenshot illustrating third party payor information according to an embodiment of the instant invention, and

FIG. 5 depicts a schematic diagram illustrating a database structure of a database according to an embodiment of the instant invention.

FIG. 6 depicts a block diagram of a typical computer system which may be used to implement this invention.

### DETAILED DESCRIPTION

In accordance with the relevant art systems, a multi-level selection process is used by a physician to capture evaluation and management (E&M) encounter information. A main menu is provided to a user for use in connection with capturing service information. The selection of any of the menu choices automatically takes the service provider to a next screen based upon the service provider's selection. Available selections comprise an evaluation and management (E&M) menu and a procedure menu.

These selections are used in connection with services being provided and with capturing of service and billing information. Upon selection, an E&M menu is displayed with options to either create a new encounter or search for data relating to a previous encounter. While either one of these options is used by the service provider, it is more likely that support staff provide information for new encounters option, and this inputted information would be saved with appropriate context information.

Any information identified in the encounter is optionally displayed, but in the illustrated case, demographic information such as the local of the encounter, the patient pre-selected, nothing needs to be entered by the physician; on the other hand, the physician or other health technician optionally changes the information as appropriate, for example, where another physician is filling in for the originally scheduled physician. Having selected a level of care, the service provider is then taken through a supporting data selection process. Requirements have been predetermined upon factors, and are sufficiently detailed to satisfy all requirements of third party payors or other responsible entities for reviewing the medical and billing records.

According to the relevant art, information is captured by a physician either during the course of the examination, or contemporaneous with the visit, for example, immediately following the visit and out of the presence of the patient.

According to the relevant art system, there is provided a demographics menu with appropriate information already entered. If a new procedure is a continuation of an encounter or an existing procedure, appropriate information fields are automatically populated. The health technician maintains the option to modify any of the relevant information provided.

Whereas the relevant art systems correctly collect information required for a proper billing procedure, a physician or other healthcare provider has first to submit a claim before he receives feedback whether the entered information is sufficient for proper and adequate billing. Often, this sort of feedback necessitates further patient evaluation, and in some cases this procedure occurs repeatedly. As such, it has a negative impact on the physician-patient relation-ship.

On the other hand, modern billing systems have achieved a level of sophistication and complexity that makes it more than difficult for an average physician to foresee the detailed steps required to successfully complete not only the physical aspect of the evaluation but the financial aspect.

The method and system according to an embodiment of the instant invention therefore provides more immediate feedback, typically displayed on a computer screen, indicating a level of complexity achieved during a patient examination, and optionally suggesting further steps needed to achieve a desired level of complexity. The invention is envisioned to be programmed in one or more high level languages such as Java, C++, C, C#, or Visual Basic. Alternately, or in addition to the high level languages the database may be programmed in MS SQL, MySQL, Oracle, Sybase, Sequel Server and like client server database products.

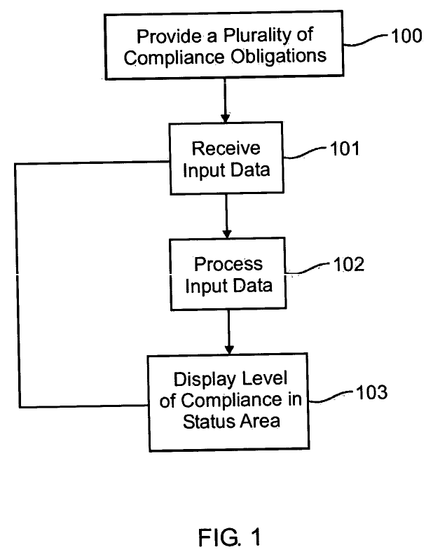

Referring now to FIG. 1, a flow chart illustrating the steps of a method for generating a visual compliance display according to a first embodiment of the instant invention. At step 100, a plurality of compliance obligations are provided. These compliance obligations provide for a set of rules or obligations necessary to comply with or achieve predetermined levels of compliance. The rules are for evaluation based on information gathered or determined during a patient visit. At step 101, a system receives input data associated with at least one of a plurality of information associated with the plurality of compliance obligations.

Typically, the information relates to healthcare history, a healthcare examination or a healthcare decision and the input data is indicative of the information. Optionally, a portion of the plurality of compliance obligations is derived from public and private insurance billing requirements. In step 102, the input data are processed to generate at least one scalable level of compliance based on the plurality of compliance obligations. Then, at step 103, the scalable level of compliance is displayed, for example on a relative scale based at least in part on a level of complexity associated with obtaining the plurality of information inputs.

Optionally, displaying of the scalable level of compliance is performed contemporaneously with receiving of input data as shown in FIG. 1; Of course, the scalable level of compliance is optionally displayed in a form indicative of a sufficient level of compliance when such is the case or a deficient level of compliance in other cases. Such a binary display of the level of compliance displayed contemporaneously is advantageous as it informs the person performing data entry that more data is necessary to achieve the requisite level of compliance. Alternatively, the level of compliance is shown separately either in time or in a separate window.

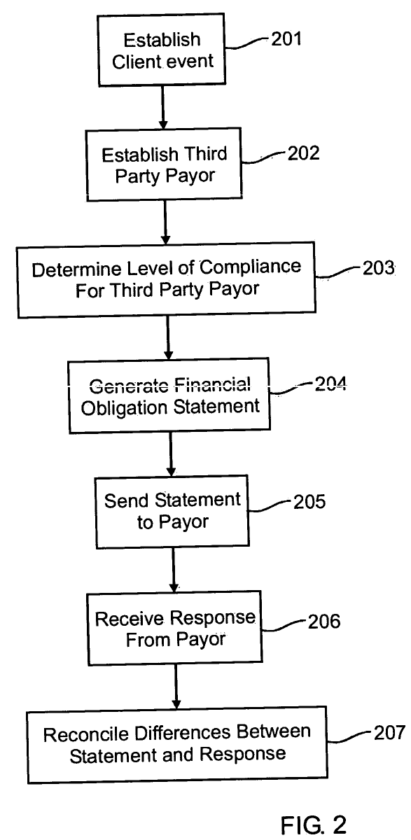

As mentioned above the system of the invention according to an embodiment, not only provides the physician with guidelines for establishing a level of complexity according to the flow chart illustrated in FIG. 1, but also with assistance for ensuring proper billing. Referring now to FIG. 2, there is displayed a flow chart illustrating the steps of a method for generating a financial obligation statement for a non-gratuitous benefit provided to a client. In step 201, an event with a client is established. Typically, this step comprises the steps of recording at least demographic information associated with a group of prospective clients attending a presentation associated with the provider, establishing at least one person of the group of prospective clients as the client, scheduling an appointment with the client, recording information of a third party payor associated with the client, providing a benefit to the client, and recording the benefit provided to the client.

The step of establishing an event with a client optionally includes receiving a referral for a prospective client. Further optionally, the step of establishing an event with a client also includes scheduling an appointment with the client, wherein the client is an established client, providing a benefit to the client, and recording the benefit provided to the client. Next, a level of compliance is determined with one or more requirements established by a third party payor in privity with the client, step 202. Preferably, but not exclusively, this step is accomplished without a clearinghouse intermediary. At step 203, the level of compliance is displayed, typically on a computer screen, and at step 204 a financial obligation statement is generated derived at least in part based on the level of compliance.

Then, at step 205, the financial obligation statement is transmitted to the third party payor. This step optionally includes a step of recording an approval event by an authorized individual associated with the provider. Further optionally, step 205 includes accumulating a plurality of financial obligation statements destined for the third party payor and transmitting the plurality of financial obligation statements to the third party payor in a batch. Next, at step 206, a reply is received from the third party payor. Typically, the reply contains payment information granted by the third party payor. Finally, at step 207, any differences between the financial obligation statement and the payment information are reconciled.

Preferably, the reconciliation is performed automatically. When considering the method as illustrated in FIG. 2, it is noted that in a one embodiment the client is a healthcare patient, the provider is a healthcare provider, and the third party payor is a public insurance provider, a private insurance provider or combination of distinct public and private insurance providers.

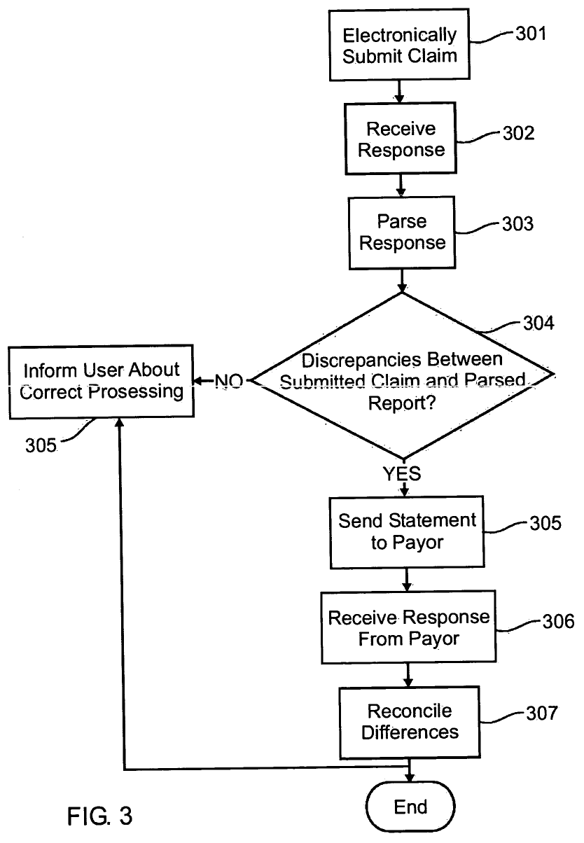

In FIG. 3, shown is a flow chart illustrating a method for automatic reconciliation of payment information received from third party payors. This feature of an embodiment of the instant invention is highly advantageous, since it not only reduces fixed costs associated with accounting tasks related to claims and payment, but also efficiently uses the new requirement of electronic submission of claims established by public third party payors to its own advantage.

In step 301, a claim is electronically submitted from a service provider in the form of a health care professional to a third party payor. A system according to an embodiment of the instant invention automatically performs the step of submitting a “proper” claim to a third party payor. In step 302, a response, in one embodiment, in electronic form, from the third party payor is received. In this response, it is listed in detail what services are actually compensated for and to what amount. In step 303, the system according to an embodiment of the instant invention parses the received report and thereby populates a plurality of data fields some of which correspond to fields within the claim. Then, in step 304, the populated data fields are compared to the filed claim. If no discrepancies are found, no further action is necessary though optionally a user of the system is informed that a claim has been properly processed, step 305.

When discrepancies are found between the claim as filed and the populated data fields, a user is informed that a claim has been incorrectly processed, step 306. Optionally, the system suggests measures to correct for errors, step 307, and further optionally initiates proper measures to correct these errors. The comparison of items claimed and items refunded which normally is performed manually and therefore consumes many man-hours of work, is now automated, performed by the system according to an embodiment of the instant invention.

In connection with the reconciliation features illustrated in FIG. 3, there is yet another advantage. There exists a significant problem in the United States regarding filing a wrongful claim. If a wrongful claim is filed and is granted, then the action of wrongfully filing the claim is possibly a fraudulent activity. Again, a claim system incorporating reconciliation as described above effectively prevents the event of fraudulent claiming thereby freeing a health care professional from serious ramifications associated with fraud.

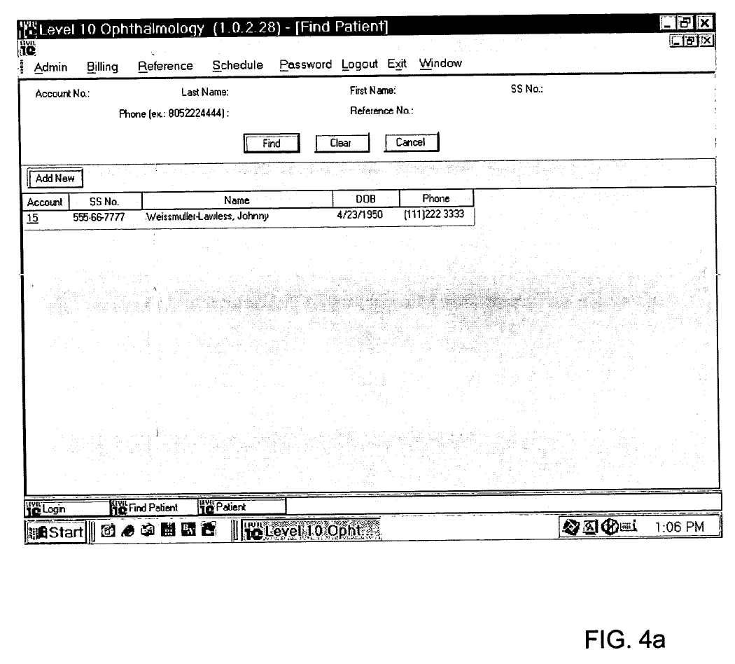

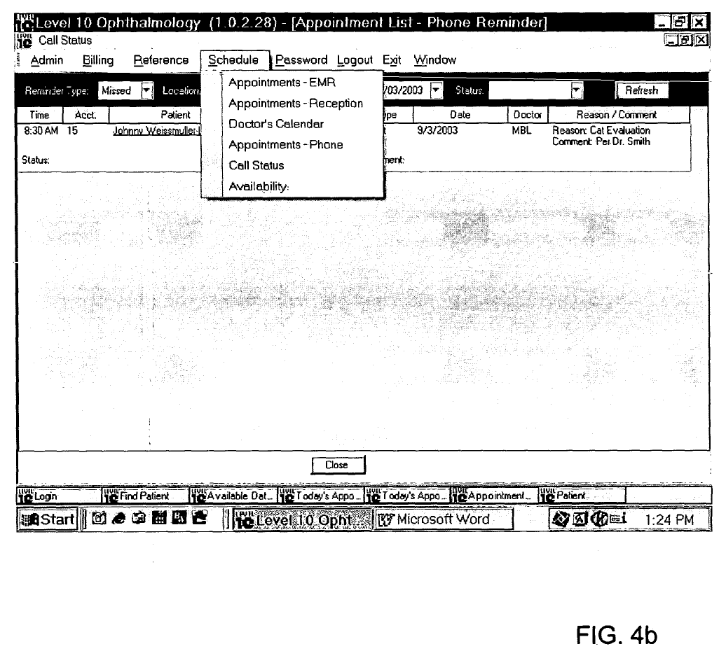

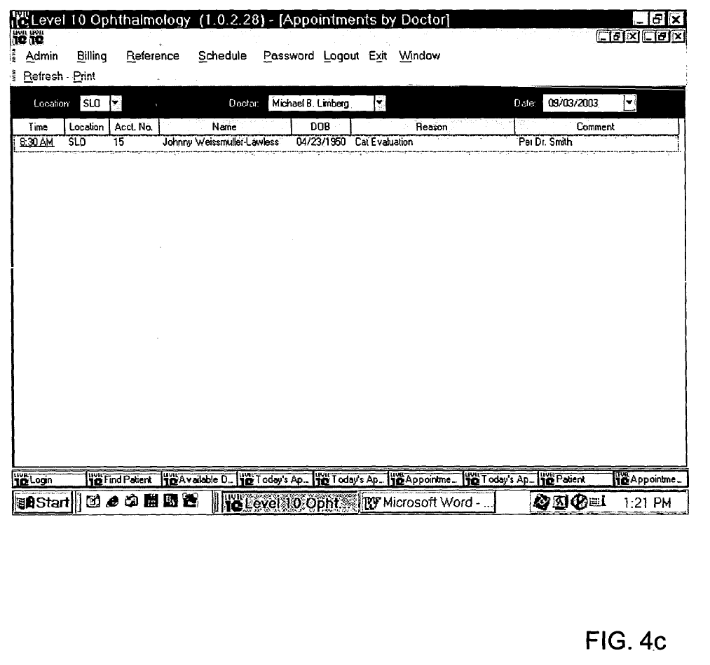

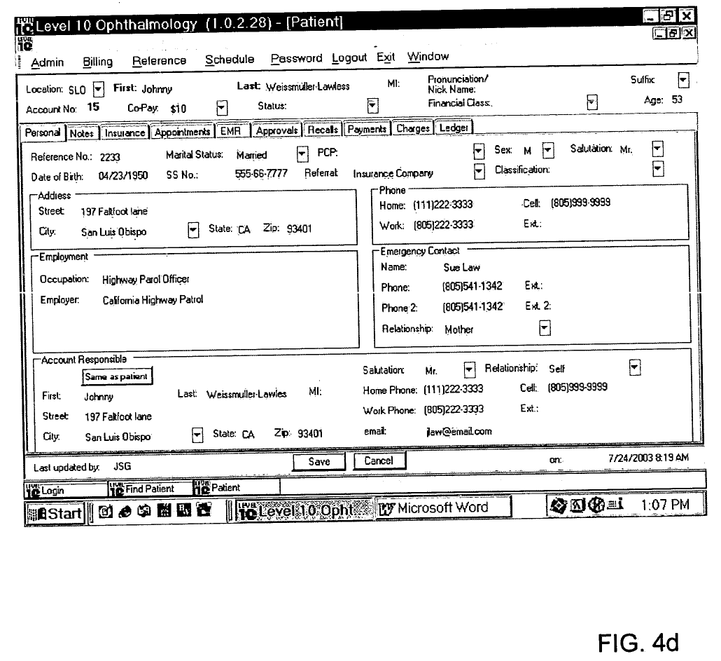

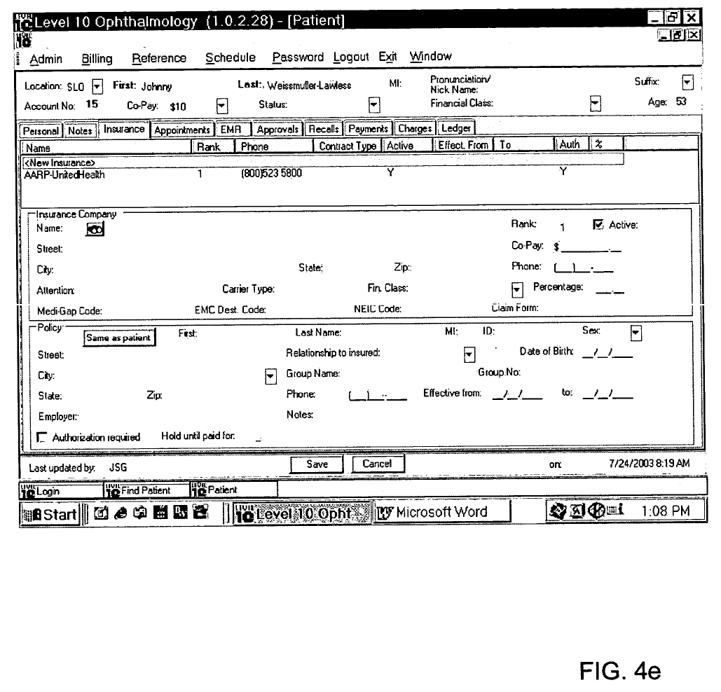

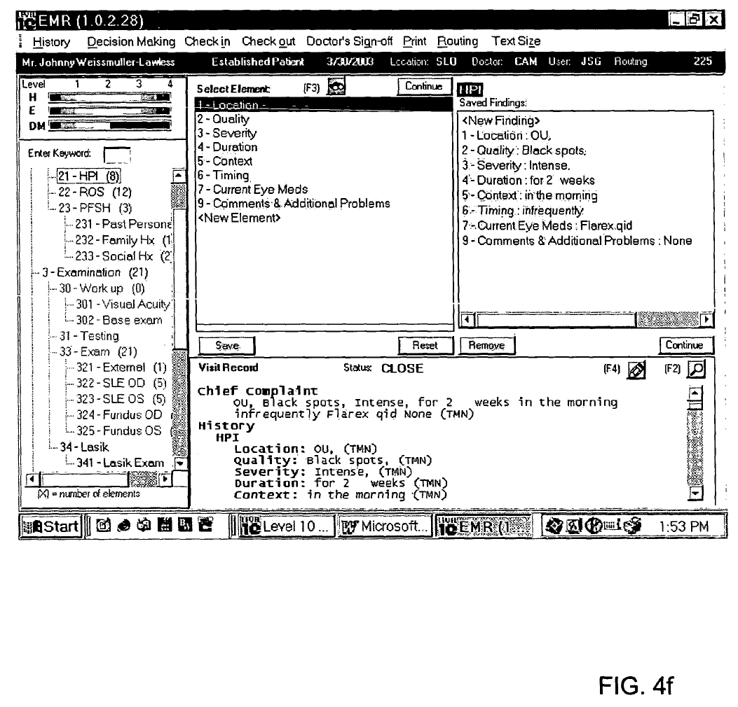

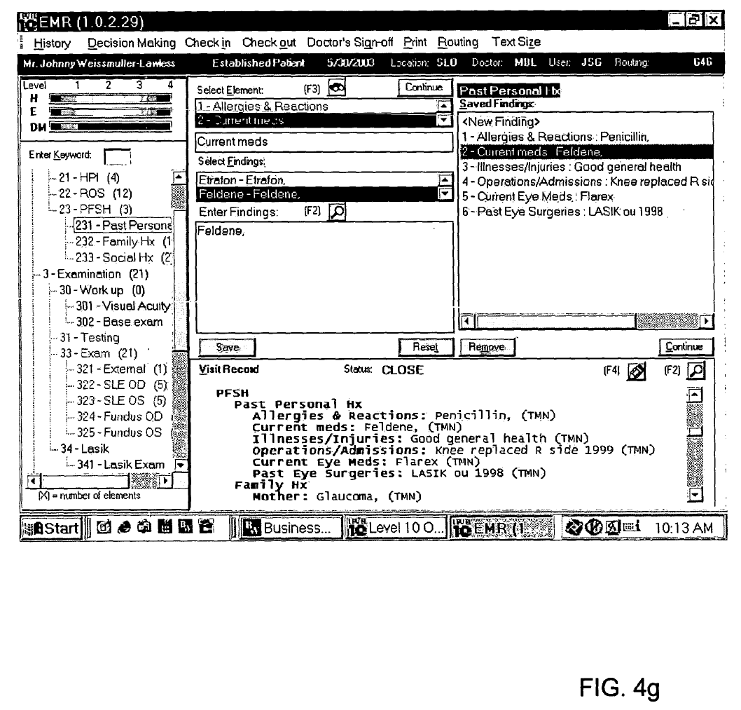

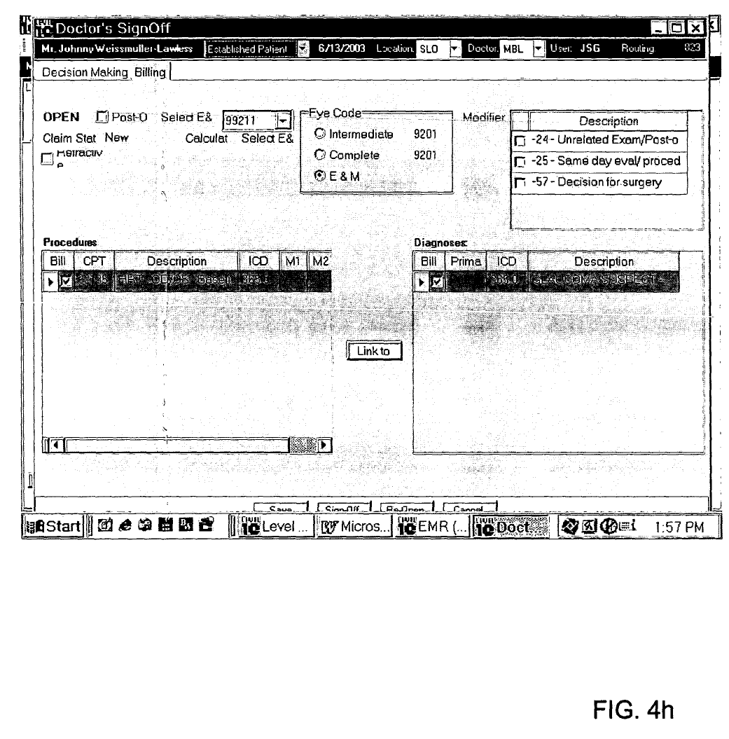

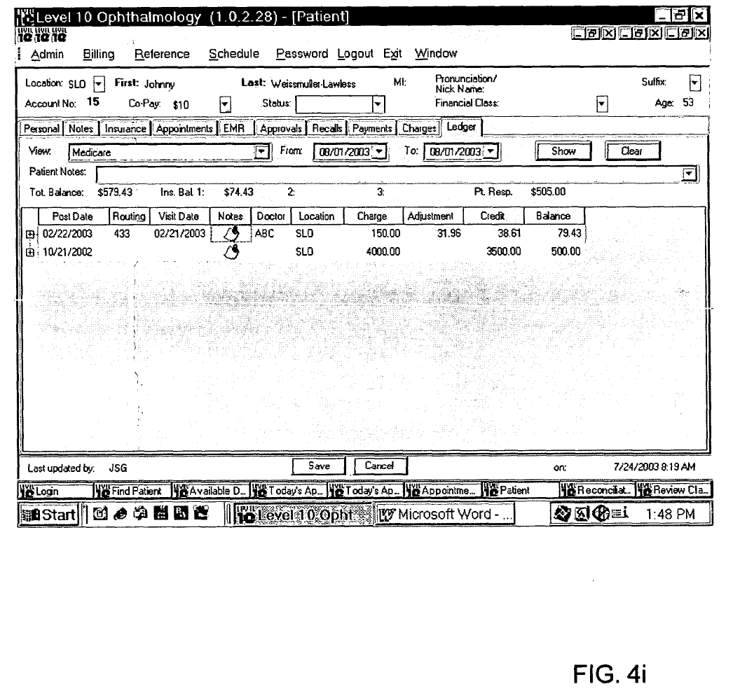

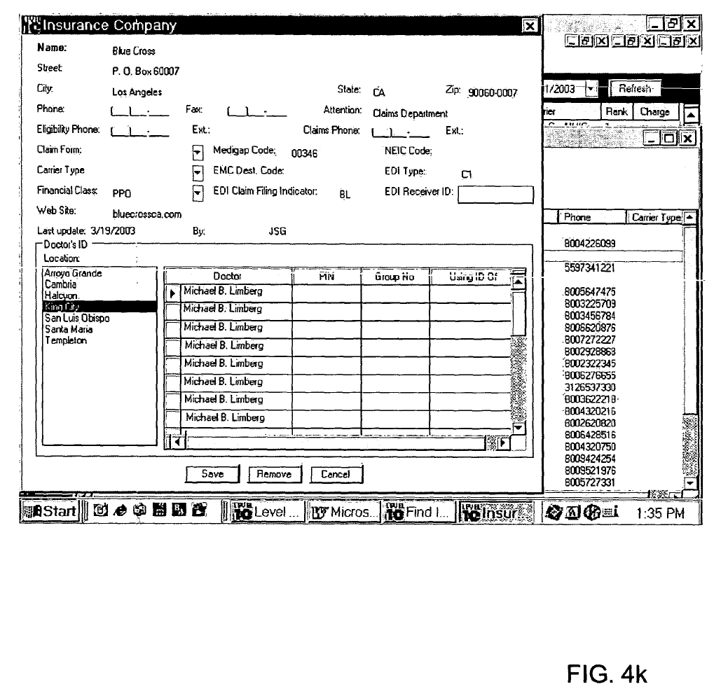

Referring now to FIGS. 4a to 4k, shown are screen shots of a system according to an embodiment of the instant invention. The screenshots are images produced from what is displayed on a computer display during execution of a method according to the invention. FIG. 4a is a screenshot illustrating an initial menu. As is evident, the system provides opportunity to find a client, add new clients, and to perform system level tasks as provided for within the menus shown along the top of the display.

FIG. 4b is a screenshot illustrating an appointment menu. The appointment menu captures events such as establishing an electronic medical record (EMR), organizing appointments, a doctor's calendar, reporting a call status, and keeping track of available time periods. Someone of skill in the art will recognize other menu items that are appropriate for a schedule menu. Using the items within the schedule menu, it is possible to schedule a health care provider office for patient visits, marketing, and time off without having to exit the financial claim system.

FIG. 4c is a screenshot illustrating patient selection. Here, a client is shown as the selected client having been searched based on a series of criteria.

FIG. 4d is a screenshot illustrating patient demographics. The patient demographics include standard patient information such as sex, date of birth, home address, phone number(s), other contact information, emergency contact information, employment status, as well as system-related reference information. The demographic information is useful for searching clients and determining service related demographics when health care is of an elective nature.

FIG. 4e is a screenshot illustrating patient insurance information. In the present example, since the client is newly entered into the system, information relating to the insurance information is to determine compliance obligations when those of the specific insurer differ from others. Thus, compliance is determinable for each patient based on their particular insurer, their plan, and the applicable legislation if any.

FIG. 4f is a screenshot illustrating an electronic medical record of a patient. This screen not only displays a patient history, and an HPI overview, but also includes complexity bars H, E, and DM, indicating instantly to the physician the achieved level of complexity. With each input data entered by the physician into the system and relating to the physician-patient interaction, the complexity bars adjust accordingly. As such, as noted in the above description, the physician is able to determine when sufficient data is provided to the system to support a level of compliance associated with a diagnosis or treatment provided. This interactive display of compliance level determination facilitates the physicians data entry by enabling rapid verification that provided input data is sufficient to support a financial claim for tendering to a third party payor.

FIG. 4g is a screenshot illustrating updating of an electronic medical record. In the upper right of the screen a patient history is displayed, whereas in the lower right, examination results are to be entered. The complexity indicators adjust according to input data provided taking into account the patient history information as well as the newly entered information. Because the complexity indicators adjust dynamically during data entry, the physician or health care provider is able to assess a completeness of the entered data for the purposes of filing a financial claim. In this way, the physician streamlines data entry through a “correct the first time” approach.

FIG. 4h is a screenshot illustrating a decision process of a physician. Here, the physician decides to sign off and proceed with a billing process. In the process, the physician selects which procedures or events for which to submit a claim and which are, for example, incomplete for claim purposes.

FIG. 4i is a screenshot illustrating an accounting status. A credit history is typically compiled from entries relating to charge, adjustment, credit, and balance. When records remain unreconciled, these are highlighted here or in association with the third party payor. Further, those amounts outstanding—unpaid by the third party payor —remain on account for payment by the patient. As payment is received, the amounts are adjusted to reflect the true status of the account.

FIG. 4k is a screenshot illustrating client information based on a third party payor. This allows for determinations of demographics and statistics based on the insurance company representing or paying for different patients. It is further noted the relevant art systems are designed for supporting traditional health care. In traditional health care, services are provided on one of a periodic basis—check-ups, dental appointments, etc.—and on an as needed basis—emergency care and illness. The goal of a practitioner practicing traditional medicine is to obtain a certain percentage of a market share. The number of sick individuals is not increased by the health care professional, and, as such, the health care professional seeks to compete or improve market share in a fixed market. However, in elective health care, the market is extensible and modifiable by getting new clients for example through marketing efforts and education.

For example, more people as a percentage of the population get plastic surgery than was the case 35 years ago. This is not a result of necessity but of desire. It is highly advantageous to support education marketing and other client gathering tools of a health care professional in an elective health care field. The systems according to the instant invention, due to their integration, allow for tracking of information related to clients and financial management information in a fashion that is beneficial not only for traditional health care providers but for non-traditional health care providers as well. Alternately, a financial management interface is provided which allows the invention to operatively couple to a financial management database provided by another vendor.

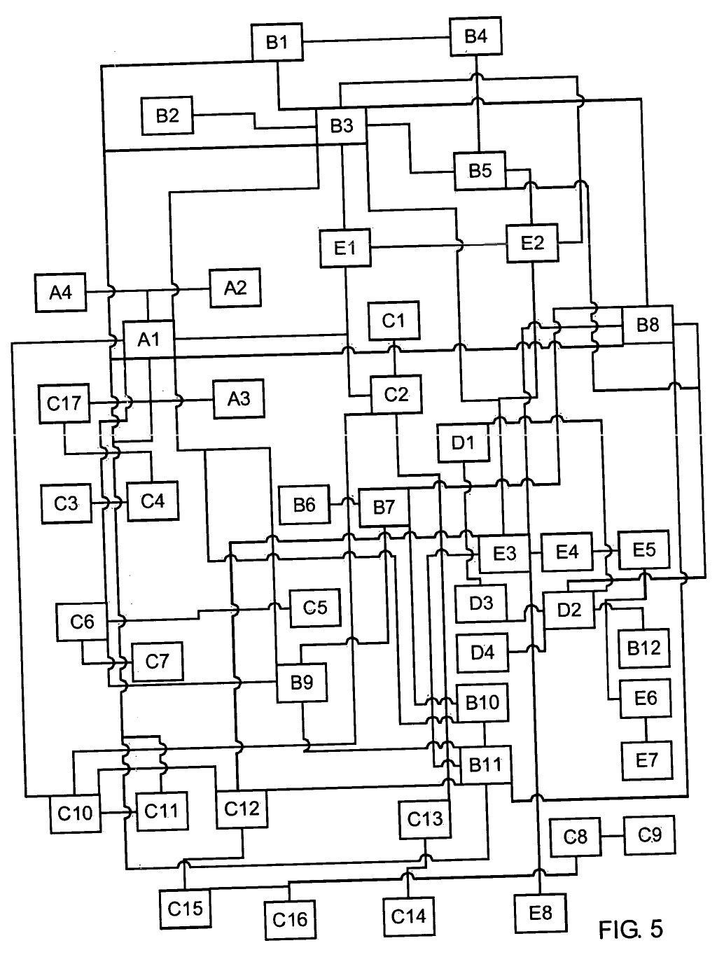

Referring now to FIG. 5, shown is a schematic diagram illustrating a database structure of a database for implementing an embodiment of the instant invention. FIG. 5 illustrates the intricate interplay between different blocks of data and the granularity of stored data. In principle the data are divided into five main categories, where “A-type” data relate to patient demographics. “B-type” data relate to specific events, “C-type” data relate to financial aspects, “D-type” data relate to medical aspects, and “E-type” data relate to provider specific issues. Another portion of the database (not shown) allows for archiving of reconciliation records. When archiving is not performed, this further portion is unnecessary. In Table 1, listed are categories of the data blocks as shown in FIG. 5.

FIG. 5 further illustrates that the many indexed connections between data files allowing for report generation supporting a plurality of different functions. As such, the integration of all of the functionality set out above is advantageous by providing for patient information, appointment information, visit record, financial information, demographics, insurer information and so forth within a single database or relationally linked set of databases. Thus, integration results in a system allowing for improved data retrieval for use in marketing and other client gathering tasks for use in elective health care provision. As such, the integrated system provides advantages heretofore unforeseen by developers of relevant art systems. Those skilled in the art will appreciate there are many varieties of user interfaces that may be employed in carrying out the invention.

One skilled in the art will also appreciate how a variety of input methods can be utilized including mechanical, voice and multimedia input methods. Thus, in addition to menu-driven or typewritten selections, in an appropriately configured system voice files and digital images are attached as part of the documentation history.

Those of skill in the art will further recognize that though the terms physician and patient are used, the system and method of the present invention also applies to dentists, pharmacists, opticians, dental and medical equipment providers, veterinarians and healthcare laboratories.

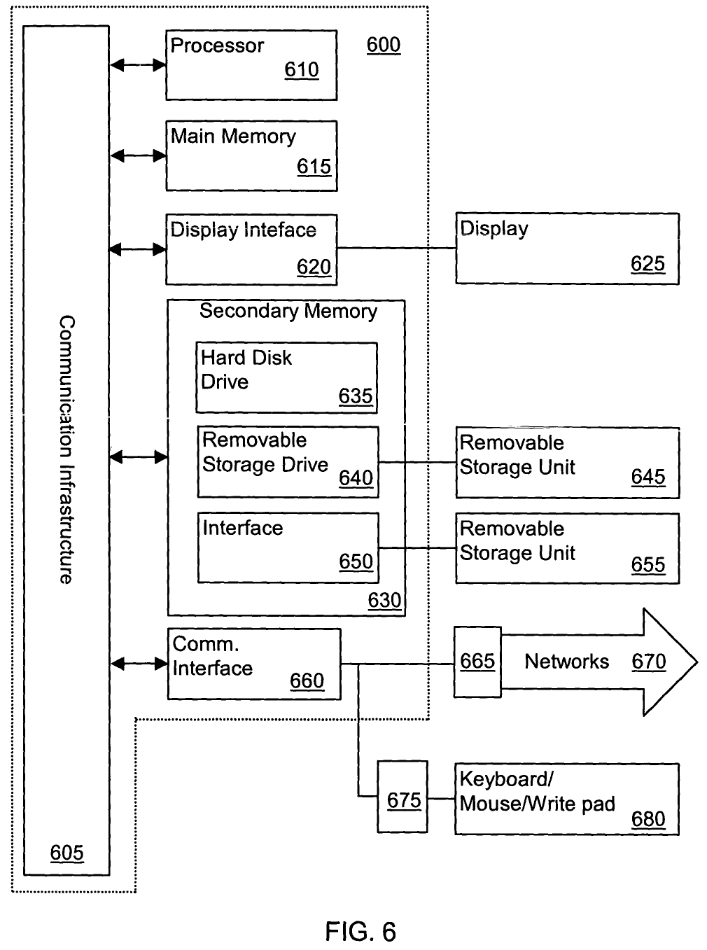

Lastly, referring to FIG. 6, a block diagram of a typical computer system such as a desktop, a workstation, a thin client, a server or a portable device such as pocket data assistant (PDA), laptop or PDA equipped cellular telephone 600 any combination of which may be used to implement the invention. The computer system 600 includes a processor 610, a main memory 615, a display 625 electrically coupled to a display interface 620, a secondary memory subsystem 630 electrically coupled to a hard disk drive 635, a removable storage drive 640 electrically coupled to a removable storage unit 645 and an auxiliary removable storage interface 650 electrically coupled to an auxiliary removable storage unit 655.

A communications interface 660 subsystem may be coupled to either a wired, optical or wireless transceiver 665 and a wired, optical or wireless network or link 670 and a user input interface 675 including a mouse, a keyboard or write pad 680. The processor 610, main memory 615, display interface 620, secondary memory subsystem 630 and communications interface system 660 are electrically coupled to a communications infrastructure 605. The computer system 600 includes an operating system, the integrated healthcare management information system software, communications applications, other applications software and hardware device interface software.

Those skilled in the art will appreciate that different portions of the invention may be installed on various computer systems in a client-server, standalone or application service provider arrangements. The foregoing described embodiments of the invention are provided as illustrations and descriptions. They are not intended to limit the invention to precise form described. In particular, it is contemplated that functional implementation of the invention described herein may be implemented equivalently in hardware, software, firmware, and/or other available functional components or building blocks. No specific limitation is intended to a particular security token operating environment. Other variations and embodiments are possible in light of above teachings, and it is not intended that this Detailed Description limit the scope of invention, but rather by the claims following herein.

TABLE 1

| | A | B | C | D | E |
|---|---|---|---|---|---|
| 1 | Patient | Schedule | Service Fee | E&M Data | Doctor |
| | | Template | | Element Group | |
| | | Header | | | |
| 2 | Classification | Appointment | Financial Class | E&M Data | Approval |
| | | Cancellation | | Element | |
| 3 | Personal Status | Appointment | Type of | E&M Data | Personnel |
| | | | Miscellaneous | Element Value | |
| | | | Charges | | |
| 4 | Referral | Schedule | Miscellaneous | E&M Data | Security role |
| | | Template | Charges | Element | Personnel |
| | | | | Category | |
| 5 | | Appointment | Payment | | Security role |
| | | Type | Method | | |
| 6 | | Visit Record | Payment | | Security Role |
| | | Child | | | Menu Item |
| 7 | | Visit Record | Payment | | Menu Item |
| | | | Receipt | | |
| 8 | | Recall | Claim | | Personnel Type |
| 9 | | Visit | Claim | | |
| | | | Diagnosis | | |
| 10 | | Visit Record - | Patient | | |
| | | Next | Insurance | | |
| | | Appointment | Company | | |
| 11 | | Location | Relationship | | |
| 12 | | Appointment | Doctor | | |
| | | Category | Insurance | | |
| | | | Company ID | | |
| 13 | | | Insurance | | |
| | | | Company | | |
| 14 | | | Carrier Type | | |
| 15 | | | Claim | | |
| | | | Insurance | | |
| | | | Company | | |
| 16 | | | Claim Service | | |
| 17 | | | Company Pay | | |

1. A method for generating a visual compliance display comprising:
providing a plurality of different compliance obligations;
providing a first user interface having a first input area, a second input area and a status area;
receiving first input data relating to an information and associated with a compliance obligation, said first input data provided to said first input area;
automatically determining a first scalable level of compliance in dependence upon compliance obligations satisfied by said first input data;
automatically displaying within said status area of said first user interface an indication based on said first scalable level of compliance;
receiving second input data relating to another information and associated with a compliance obligation, said second input data provided to said second input area;
automatically determining a second scalable level of compliance in dependence upon compliance obligations satisfied by said first input data and said second input data; and
automatically displaying within said status area of said first user interface an indication based on said second scalable level of compliance.

2. The method according to claim 1 wherein said indication is a visual indication displayed within said status area is displayed as a scale that is representative of a level of compliance.

3. The method according to claim 1 wherein said indication is a visual indication and wherein upon receiving of input data said visual indication displayed within said status area is an update to that which has been previously displayed.

4. The method according to claim 1 wherein said indication is based on a relative scale of level of compliance based at least in part on a level of complexity associated with obtaining said first input data and said second input data.

5. The method according to claim 1 wherein said first input data and said second input data are associated with data derived from healthcare data.

6. The method according to claim 1 wherein said first input data and said second input data are derived from client event information.

7. The method according to claim 1 wherein upon reviewing said status area and said information displayed therein, a provider of said input data has sufficient information to determine when said input data provided is sufficient for supporting a claim for payment dependent upon meeting predetermined compliance obligations.

8. The method according to claim 7 comprising the step of when said input data is insufficient to support said claim for payment, entering additional information in order to meet said predetermined compliance obligations.

9. The method according to claim 1 comprising the step of establishing an event with a client prior to step 1.c.

10. The method according to claim 9 wherein said plurality of different compliance obligations include one or more requirements established by a third party payor in privity with said client.

11. The method according to claim 10 comprising the step of generating a financial obligation statement upon meeting predetermined compliance obligations.

12. The method according to claim 11 comprising the step of transmitting said financial obligation statement to said third party payor.

13. The method according to claim 12 comprising the step of receiving a reply from said third party payor, wherein said reply comprises payment information for payment by said third party payor.

14. The method according to claim 13 comprising the step of automatically reconciling differences between said financial obligation statement and said payment information.

15. The method according to claim 13 wherein said client is a healthcare patient, said provider is a healthcare provider, and said third party payor is one of a public insurance provider and a private insurance provider and a combination of distinct public and private insurance providers.

16. The method according to claim 12 comprising the step of accumulating a plurality of financial obligation statements destined for said third party payor; and wherein said step of transmitting said financial obligation statement comprises said step of: transmitting said plurality of financial obligation statements to said third party payor in a batch.

17. The method according to claim 16 wherein said steps of accumulating and transmitting are accomplished absent a clearinghouse intermediary.

18. A method for generating a financial obligation statement for a non-gratuitous benefit provided to a client comprising the steps of:
a. establishing an event with a client;
b. determining a level of compliance with one or more requirements established by a third party payor in privity with said client;
c. displaying said level of compliance;
d. generating a financial obligation statement derived at least in part from said level of compliance; and,
e. transmitting said financial obligation statement to said third party payor.

19. The method according to claim 18 wherein said estimating an event includes:
recording at least demographic information associated with a group of prospective clients attending a presentation associated with said provider;
establishing at least one of said group of said prospective clients as said client;
scheduling an appointment with said client;
recording information associated with said third party payor;
providing a benefit to said client; and,
recording said benefit provided to said client.

20. The method according to claim 18 wherein said estimating an event includes:
receiving a referral for a prospective client;
establishing said prospective client as said client;
scheduling an appointment with said client;
recording information associated with said third party payor;
providing a benefit to said client; and,
recording said benefit provided to said client.

21. The method according to claim 18 wherein said estimating an event includes:
scheduling an appointment with said client, wherein said client is an established client;
providing a benefit to said client; and,
recording said benefit provided to said client.

22. The method according to claim 18 wherein said transmitting includes recording an approval provided by an authorized individual associated with said provider.

19. The method according to claim 18 wherein said estimating an event includes:
recording at least demographic information associated with a group of prospective clients attending a presentation associated with said provider;
establishing at least one of said group of said prospective clients as said client;
scheduling an appointment with said client;
recording information associated with said third party payor;
providing a benefit to said client; and,
recording said benefit provided to said client.

20. The method according to claim 18 wherein said estimating an event includes:
receiving a referral for a prospective client;
establishing said prospective client as said client;
scheduling an appointment with said client;
recording information associated with said third party payor;
providing a benefit to said client; and,
recording said benefit provided to said client.

21. The method according to claim 18 wherein said estimating an event includes:
scheduling an appointment with said client, wherein said client is an established client;
providing a benefit to said client; and,
recording said benefit provided to said client.

22. The method according to claim 18 wherein said transmitting includes recording an approval provided by an authorized individual associated with said provider.

23. The method according to claim 18 further including;
receiving a reply from said third party payor, wherein said reply comprises payment information granted by said third party payor; and,
automatically reconciling differences between said financial obligation statement and said payment information.

24. The method according to claim 18 wherein said client is a healthcare patient, said provider is a healthcare provider, and said third party payor is a public insurance provider, a private insurance provider or combination of distinct public and private insurance providers.

25. The method according to claim 18 wherein said transmitting includes:
accumulating a plurality of financial obligation statements destined for said third party payor; and,
transmitting said plurality of financial obligation statements to said third party payor in a batch.

26. The method according to claim 25 wherein said accumulation is accomplished absent a clearinghouse intermediary.

27. A system for generating a financial obligation statement for a non-gratuitous benefit provided to a client for provision to a third party payor comprising:
a computer system comprising;
a processor;
a user interface coupled to said processor;
a display interface coupled to said processor;
a telecommunications apparatus coupled to said processor;
a memory coupled to said processor, said memory having operatively stored therein a data structure comprising information associated with a client; and,
at least one application comprising instructions executable by said processor for carrying out the steps of:
determining a level of compliance from said information,
displaying said level of compliance on said display interface,
generate a financial obligation statement from said information, and
transmitting said financial obligation statement to said third party payor via said telecommunications apparatus.

28. The system according to claim 27 wherein said data structure comprises a database having stored therein a plurality of client data including information associated with said client.

29. The system according to claim 28 wherein said database comprises;
a client data storage area having at least one client record associated with said client stored therein;
an events data storage area having at least one event record associated with said client stored therein;
a third party payor data storage area having at least one third party payor record associated with said client stored therein; and,
a benefits data storage area having at least one benefit record associated with said client stored therein.

30. The system according to claim 28 wherein said database is disposed on a server in data exchange communication with said computer system.

31. The system according to claim 27 wherein said level of compliance is displayed on said display interface in a visual manner that is indicative of the level of compliance.

32. The system according to claim 31 wherein said relative scale is based at least in part on a level of complexity associated with obtaining said information.

33. The system according to claim 27 wherein said display interface includes an end user customizable graphical user interface.

34. An integrated healthcare management information system comprising:
a financial claim generation system comprising:
a database management system,
a data entry system,
a financial obligation statement verification system, and,
a financial obligation statement submission system; and,
a claim reconciliation system comprising:
a payment information receiving system,
a payment information parsing system,
a payment information reconciliation system for reconciling received payment information with claims generated and submitted by the financial claim generation system, and
a reconciliation error management system.

35. The integrated healthcare management information system according to claim 34 wherein the reconciliation error management system comprises a system for automatic correction of some reconciliation errors.

36. The integrated healthcare management information system according to claim 34 implemented within at least a client computer system operatively coupled to a network and in data communications with at least a remote server over said network.

37. The integrated healthcare management information system according to claim 36 comprising an end user customizable graphical user interface.

38. The integrated healthcare management information system according to claim 37 comprising at least a remote server for receiving a request for retrieval of at least a portion of said information stored within said at least a remote server, for transferring said requested at least a portion of said information from said at least a remote server to said at least a client computer, and wherein said at least a client computer system is for displaying at least a portion of said transferred information using said end user customizable graphical user interface.

39. The integrated healthcare management information system according to claim 38 wherein the at least a client computer system is for controlling said at least a remote server to generate at least one financial obligation statement and for resulting in said at least one remote server to transmit said at least one financial obligation statement to a third party payor and wherein said at least a client computer system is for automatically reconciling differences between said at least one financial obligation statement and said payment information.

40. An integrated healthcare management information system comprising:
at least one networked server coupled to a substantially ODBC compliant database system having a plurality of relationally linked data structures, each data structure comprising;
a patient healthcare data storage area;
an events data storage area;
a third party payor data storage area;
a provider data storage area; and,
a payment data storage area, wherein said data storage areas each include at least one attribute in common with said patient healthcare table; and
at least a client terminal comprising a processor;
a user interface coupled to said processor;
a display interface coupled to said processor; and,
a telecommunication apparatus for resulting in communication with said at least one networked server for extracting data from at least a portion of the plurality of relationally linked data structures and for storing data within at least a portion of said plurality of relationally linked data structures; and wherein said client terminal for executing at least one front end application compatible with said data structure and including an end user customizable graphical user interface.

41. The integrated healthcare management information system according to claim 40 wherein said patient healthcare data storage area includes patient history information, patient medical status information and medical decision information.

42. The integrated healthcare management information system according to claim 40 wherein said events data storage area includes patient appointment information, patient office visit information and provider schedule information.

43. The integrated healthcare management information system according to claim 40 wherein said third party payor data storage area includes private insurer information, public insurer information, private insurer payor rules, and public insurer payer rules.

44. The integrated healthcare management information system according to claim 40 wherein said provider data storage area includes provider office location information, provider administrative information, provider database security information.

45. The integrated healthcare management information system according to claim 40 wherein said payment data storage area includes patient payment information, third party payment information and payment reconciliation information.

46. The integrated healthcare management information system according to claim 40 further including a financial management data storage area.

47. The integrated healthcare management information system according to claim 46 wherein said financial management data storage area includes financial accounting information, profitability information, income information and expense information.

48. The integrated healthcare management information system according to claim 40 further including a financial management interface for operatively coupling to a financial management database.

49. A processing system for carrying out the steps of:
providing a plurality of different compliance obligations;
providing a first user interface having a first input area, a second input area, and a status area;
receiving first input data relating to an information and associated with a compliance obligation, said first input data provided to said first input area;
automatically determining a first scalable level of compliance in dependence upon compliance obligations satisfied by said first input data;
automatically displaying within said status area of said first user interface an indication based on said first scalable level of compliance;
receiving second input data relating to another information and associated with a compliance obligation, said second input data provided to said second input area;
automatically determining a second scalable level of compliance in dependence upon compliance obligations satisfied by said first input data and said second input data; and
automatically displaying within said status area of said first user interface an indication based on said second scalable level of compliance.

50. A computer readable medium having data stored thereon comprising:
first instruction data for when executed providing a plurality of different compliance obligations;
second instruction data for when executed providing a first user interface having a first input area, a second input area, and a status area;
third instruction data for when executed receiving first input data relating to an information and associated with a compliance obligation, said first input data provided to said first input area;
fourth instruction data for when executed automatically determining a first scalable level of compliance in dependence upon compliance obligations satisfied by said first input data;
fifth instruction data for when executed automatically displaying within said status area of said first user interface an indication based on said first scalable level of compliance;
sixth instruction data for when executed receiving second input data relating to another information and associated with a compliance obligation, said second input data provided to said second input area;
seventh instruction data for when executed automatically determining a second scalable level of compliance in dependence upon compliance obligations satisfied by said first input data and said second input data; and
eighth instruction data for when executed automatically displaying within said status area of said first user interface an indication based on said second scalable level of compliance.

51. A computer program product embodied in a tangible form readable by at least one processor having executable instructions stored thereon for causing said at least one processor to at least determine a level of compliance from inputted information, display said level of compliance on a display interface, generate a financial obligation statement from said inputted information, and transmit said financial obligation statement to a third party payor via a coupled telecommunications apparatus.

52. The computer program product according to claim 51 wherein said tangible form includes magnetic media, optical media or logical media.

53. The computer program product according to claim 51 wherein said executable instructions are stored in a code format comprising byte code, compiled, interpreted, compliable and interpretable.
